(19) United States
(12) Patent Application Publication
(10) Pub. No.: US 2015/0253859 A1
(43) Pub. Date: Sep. 10, 2015

(54) SYSTEM AND METHOD FOR PHYSICAL MANIPULATION OF OBJECT AND TYPE OF OBJECT AS INPUT

(71) Applicant: Google Inc., Mountain View, CA (US)

(72) Inventors: Jonah Jones, San Francisco, CA (US); Steven Maxwell Seitz, Seattle, WA (US)

(73) Assignee: GOOGLE INC., Mountain View, CA (US)

(21) Appl. No.: 14/197,798

(22) Filed: Mar. 5, 2014

(51) Int. Cl. G06F 3/01

(52) U.S. Cl. CPC G06F 3/017

(57) ABSTRACT

A system and method is provided of detecting user manipulation of an inanimate object and interpreting that manipulation as input. In one aspect, the manipulation may be detected by an image capturing component of a computing device, and the manipulation is interpreted as an instruction to execute a command, such as opening up a drawing application in response to a user picking up a pen. The manipulation may also be detected with the aid of an audio capturing device, e.g., a microphone on the computing device.

### BACKGROUND

Gesture recognition technology relates to the understanding of human gestures using computers and mathematical algorithms. Gestures may include any motion of the human body, particularly of the hand and face and may be used to communicate with machines. For example, a user may be able to move a computer cursor by pointing and moving the user's finger. The user's physical movement can be captured by various devices, such as wired gloves, depth-aware cameras, remote controllers, and standard 2-D cameras.

### BRIEF SUMMARY

In one aspect, a method for detecting as input physical manipulations of objects comprises receiving, using one or more computing devices, a first image and detecting, using the one or more computing devices, an object type in the first image. Similarly, the method also comprises receiving, using the one or more computing devices, a second image and detecting the object type in the second image. Moreover, the method comprises determining using the one or more computing devices a manipulation of the object type based at least in part on the analysis of the object type in the first image and the second image, determining using the one or more computing devices an input to associate with the determined manipulation of the object type, determining using the one or more computing devices one or more executable commands associated with the determined input, and executing using the one or more computing devices the one or more executable commands.

In another aspect, a system comprises a camera, one or more processors, and a memory. The memory stores a plurality of object types, an object-manipulation pair for each object type where each object-manipulation pair associates the object type with a manipulation of the object type, and at least one command associated with each object-manipulation pair. The memory may also store instructions, executable by the processor. The instructions comprise determining an object type based on information received from the camera, determining a manipulation by a user of the determined object type based on information received form the camera, and when the determined object type and manipulation correspond with an object-manipulation pair of the determined object type, executing the command associated with the object-manipulation pair.

In still another aspect, a non-transitory, tangible computer-readable medium on which instructions are stored, the instructions, when executed by one or more computing devices, performs a method for detecting as input physical manipulations of objects comprises receiving a first image, detecting an object type in the first image, receiving a second image, and detecting the object type in the second image. Moreover, the method comprises determining a manipulation of the object type based at least in part on the analysis of the object type in the first image and the second image, determining an input to associate with the determined manipulation of the object type, determining one or more executable commands associated with the determined input, and executing the one or more executable commands.

### BRIEF DESCRIPTION OF THE DRAWINGS

FIG. 1 is a functional diagram of a system in accordance with an aspect of the present disclosure.

FIG. 2 is a functional diagram illustrating computing devices communicating with a system in accordance with an aspect of the present disclosure.

FIG. 3 is a diagram illustrating object types, object-manipulation pairs, and executable commands stored in memory in accordance with an aspect of the present disclosure.

FIG. 4 is an illustration of a computing device capturing a user's hand manipulating a pen.

FIG. 5 is an illustration of a computing device capturing a user's hand manipulating a watch.

FIG. 6 is an illustration of a computing device capturing a user's hand manipulating a ring.

FIG. 7 is a flow diagram depicting an execution of an instruction set stored in memory of a system for detecting as input physical manipulations of objects in accordance with another aspect of the present disclosure.

FIG. 8 is a flow diagram depicting a method for detecting as input physical manipulations of objects in accordance with an aspect of the present disclosure.

### DETAILED DESCRIPTION

### Overview

The technology generally pertains to detecting user manipulation of an inanimate object and interpreting that manipulation as input. For example, the manipulation may be detected by an image capturing component of a computing device that is on or near a user, such as a camera on a wearable device or mobile phone. The computing device coupled to the camera may interpret the manipulation as an instruction to execute a command, such as opening up a drawing application in response to a user picking up a pen. The manipulation may also be detected with the aid of an audio capturing device, e.g., a microphone on a wearable device.

The computing device may be configured to constantly observe, detect, and subsequently interpret a manipulation of an inanimate object as an instruction to execute a particular command, which can be as simple as starting a process. The association among the type of an object, a particular manipulation of that type of object, and the command may be stored in memory. For example, a user may manually enter an association between a manipulation of a particular object and a command, such as opening the e-mail application when the user clicks a pen twice. The device's camera and microphone may observe the manipulation, use object recognition to recognize the type of object and type of manipulation, and associate the type of object and type of manipulation with the command. By way of further example, the device may interpret the user touching the outer circumference of a watch as a command to open up the alarm application. Particular manipulations and executable commands may also be received from other sources (e.g., downloaded from a third-party server) or learned by observation over time.

The object may be a common object that is incapable of transmitting information to the device, the manipulation may be a common use of the object, and the command may be related to the type of the object. For instance, the device may dial the user's spouse's cell phone number every time he or she rotates his or her wedding ring. In another instance, the client device may open up a wallet application when the user physically pulls out a wallet.

Different manipulations of the same object may result in different commands. Referring back to the watch example above, the device may interpret two taps on the glass of the watch as a command to open up the calendar application. The user may then rotate their thumb and index fingers clockwise, or counter-clockwise, to toggle the calendar cursor forward or backward, respectively.

Over a certain period of time, the client computing device may observe how the user manipulates various objects and determine whether there is a correlation with subsequent commands. For instance, after opening up the e-mail application upon two clicks of a pen, the device may observe that the user consistently clicks the pen again before creating a new e-mail. The device may store this observation in its memory and automatically create a new e-mail for the user the next time she clicks her pen after opening up the e-mail application.

An external display device may be coupled to the device and project a display of related to the object and manipulation. For example, the display may project a drawing surface when the user picks up a pen.

Example Systems

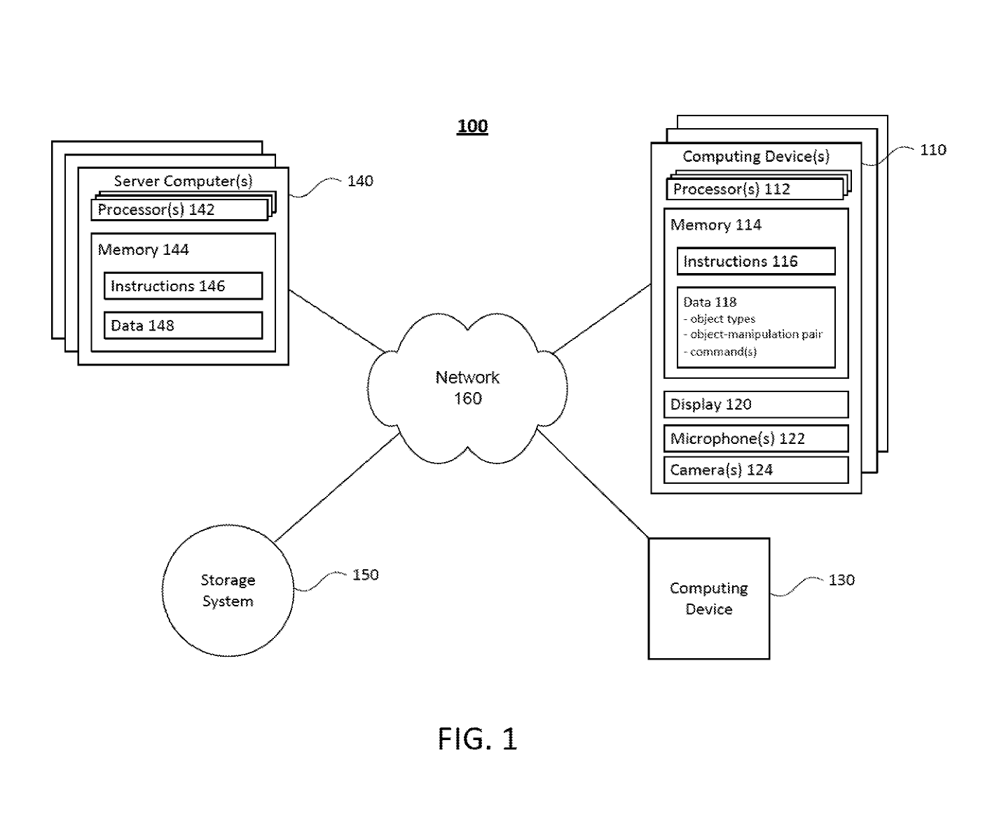

FIG. 1 illustrates one possible system 100 in which the aspects disclosed herein may be implemented. In this example, system 100 may include computing devices 110 and 130. Computing device(s) 110 may contain one or more processors 112, a memory 114, a display 120, microphone(s) 122, camera(s) 124 and other components typically present in general purpose computing devices. Although FIG. 1 functionally represents each of the processor(s) 112 and memory 114 as a single block within device(s) 110, which is also represented as a single block, the system may include and the methods described herein may involve multiple processors, memories and devices that may or may not be stored within the same physical housing. For instance, various examples and methods described below as involving a single component (e.g., memory 114) may involve a plurality of components (e.g., multiple computing devices distributed over a network of computing devices, computers, “racks,” etc. as part of a parallel or distributed implementation; further, the various functions performed by the embodiments may be executed by different computing devices at different times as load is shifted from among computing devices). Similarly, various examples and methods described below as involving different components (e.g., device(s) 110 and device 130) may involve a single component (e.g., rather than device 130 performing a determination described below, device 130 may send the relevant data to device(s) 110 for processing and receive the results of the determination for further processing or display).

Memory 114 of computing device(s) 110 may store information accessible by processor(s) 112, including instructions 116 that may be executed by the processor(s) 112. Memory 114 may also include data 118 that may be retrieved, manipulated or stored by processor 112. Memory 114 and the other memories described herein may be any type of storage capable of storing information accessible by the relevant processor, such as a hard-disk drive, a solid state drive, a memory card, RAM, ROM, DVD, write-capable memory or read-only memories. In addition, the memory may include a distributed storage system where data, such as data 118, is stored on a plurality of different storage devices which may be physically located at the same or different geographic locations.

The instructions 116 may be any set of instructions to be executed by processor(s) 112 or other computing devices. In that regard, the terms “instructions,” “application,” “steps” and “programs” may be used interchangeably herein. The instructions may be stored in object code format for immediate processing by a processor, or in another computing device language including scripts or collections of independent source code modules, that are interpreted on demand or compiled in advance. Functions, methods and routines of the instructions are explained in more detail below. Processor(s) 112 may each be any conventional processor, such as a commercially available central processing unit (“CPU”) or a graphics processing unit (“GPU”). Alternatively, the processor may be a dedicated component such as an application-specific integrated circuit (“ASIC”), a field programmable gate array (“FPGA”), or other hardware-based processor.

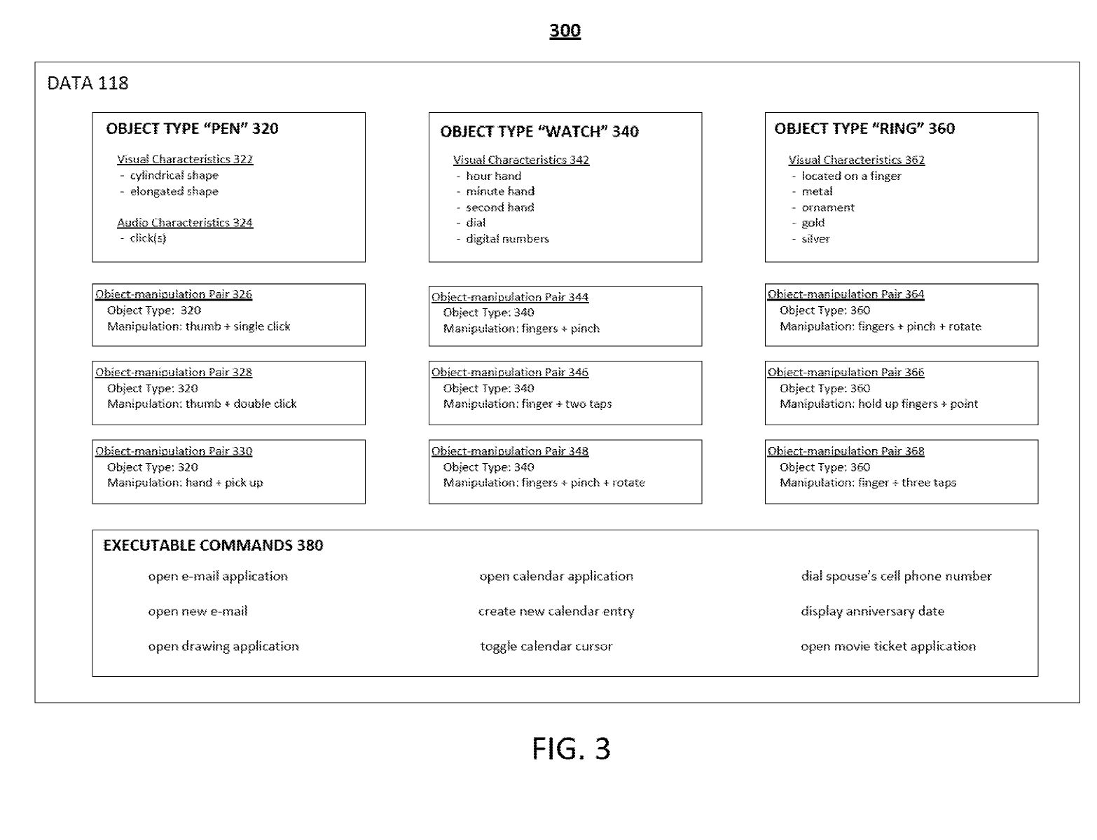

Data 118 may be retrieved, stored or modified by computing device(s) 110 in accordance with the instructions 116. For instance, although the subject matter described herein is not limited by any particular data structure, the data may be stored in computer registers, in a relational database as a table having many different fields and records, or XML documents. The data may also be formatted in any computing device-readable format such as, but not limited to, binary values, ASCII or Unicode. Moreover, the data may comprise any information sufficient to identify the relevant information, such as numbers, descriptive text, proprietary codes, pointers, references to data stored in other memories such as at other network locations, or information that is used by a function to calculate the relevant data. As discussed in more detail below with regard to FIG. 3, data 118 may comprise, for example, at least an object type, an object-manipulation pair, and a command associated with the object-manipulation pair.

Display 120 and other displays described herein may be any type of display, such as a monitor having a screen, a touch-screen, a projector, or a television. Display 120 of computing device(s) 110 may electronically display information to a user via a graphical user interface (“GUI”) or other types of user interfaces. Microphone(s) 122 of computing device(s) 110 may detect and capture any type of audio input. Microphone(s) 122 and other microphones may be any type of audio capturing component, such as an electret microphone, a carbon microphone, a fiber optic microphone, a dynamic microphone, a ribbon microphone, a laser microphone, a condensor microphone, a cardioid microphone, or a crystal microphone. Camera(s) 124 of computing device(s) 110 may detect and capture any type of image or a series of images based on light, heat, or the like. Camera(s) 124 and other cameras described in the present disclosure may be any type of image capturing component, such as a video camera, a camera phone, a virtual camera, a still camera, a digital camera, a range camera, a 3-D camera, an infrared camera, or any component coupled to an image sensor (e.g., CCD, CMOS). Display 120, microphone(s) 122, and camera(s) 124 may be packaged into one device, as shown in computing device(s) 110, or they may also be individually coupled as system.

Computing devices 110 and 130 may be at one node of a network 160 and capable of directly and indirectly communicating with other nodes of network 160, such as one or more server computer(s) 140 and a storage system 150. Although only a few computing devices are depicted in FIG. 1, a typical system may include a large number of connected computing devices, with each different computing device being at a different node of the network 160. The network 160 and intervening nodes described herein may be interconnected using various protocols and systems, such that the network may be part of the Internet, World Wide Web, specific intranets, wide area networks, or local networks. The network may utilize standard communications protocols, such as Ethernet, Wi-Fi and HTTP, protocols that are proprietary to one or more companies, and various combinations thereof. Although certain advantages are obtained when information is transmitted or received as noted above, other aspects of the subject matter described herein are not limited to any particular manner of transmission of information.

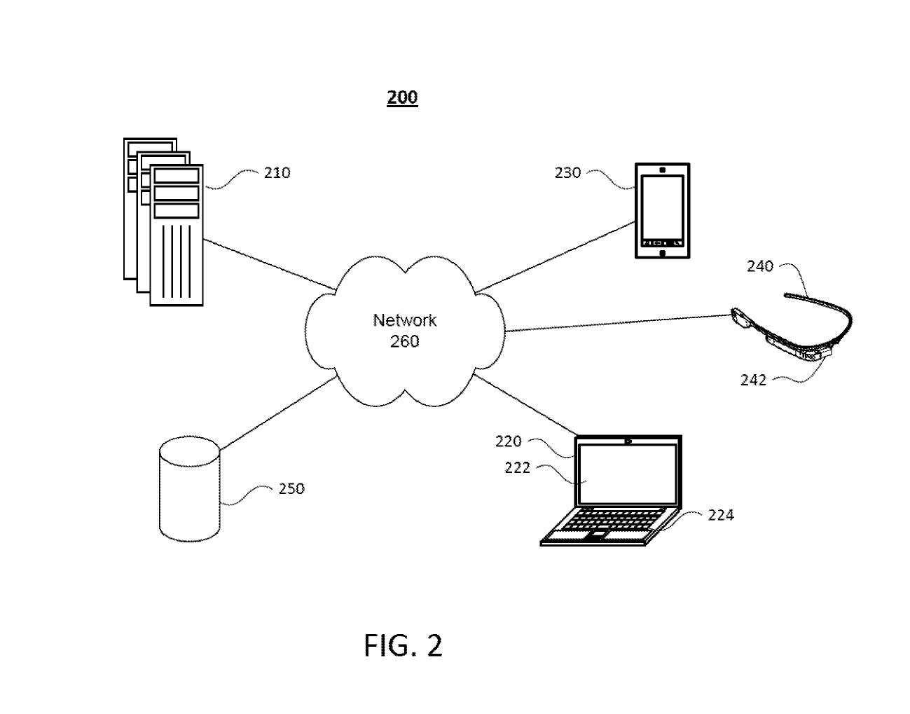

As an example, server computer(s) 140 may be a web server that is capable of communicating with computing device(s) 110 via the network 160. As discussed in more detail below with regard to FIG. 2, computing device(s) 110 and computing device 130 may be client computing devices or other user devices, and server computer(s) 140 may provide information for display by using network 160 to transmit and present information to a user of device(s) 110 or device 130.

As another example, storage system 150 may store various object types, object-manipulation pairs, and respective executable commands in addition to the ones stored in data 118. As with memory 114, storage system 150 can be of any type of computerized storage capable of storing information accessible by server computer(s) 140, such as hard-drive, memory card, ROM, RAM, DVD, CD-ROM, write-cable, and read-only memories. Moreover, storage system 150 may include a distributed storage system where data is stored on a plurality of different storage devices that may be physically located at the same or different geographic locations. Storage System 150 may be connected to the computing devices via the network 160 as shown in FIG. 1 and/or may be directly connected to or incorporated into any of the computing devices, e.g., 110 and 130 (not shown).

FIG. 2 is a diagram depicting a variety of computing devices of one possible system 200. For example, computing device(s) 110 in FIG. 1 may be a personal computing device 220, such as a laptop, intended for use by a user. The personal computing device 220 may have all of the components normally used in connection with a personal computing device such as a CPU or GPU, memory storing data and instructions, a display such as display 222 (e.g., a monitor having a screen, a touch-screen, a projector, a television, or other device that is operable to display information), and user input device 224 (e.g., a mouse, keyboard, touch-screen, microphone, etc.). Computing device(s) 110 may also comprise a mobile computing device 230 capable of wirelessly exchanging data with a server over a network such as the Internet. By way of example only, mobile computing device 220 may be a mobile phone or a device such as a wireless-enabled PDA, a tablet PC, or a netbook that is capable of obtaining information via the internet. Computing device(s) 110 may also comprise a wearable computing device 240 having a CPU or GPU, memory, a display 242, a camera, and a microphone.

The device may be configured to operate with an operating system such as Google's Android operating system, Microsoft Windows or Apple iOS. In that regard, some of the instructions executed during the operations described herein may be provided by the operating system whereas other instructions may be provided by an application installed on the device. Computing devices 110 and 130, as shown in FIG. 1, and other computing devices in accordance with the systems and methods described herein may include other devices capable of processing instructions and transmitting data to and from humans and/or other computers including network computers lacking local storage capability and set top boxes for televisions.

FIG. 3 is a diagram 300 illustrating different object types, object-manipulation pairs for each object type, and executable commands associated with the object-manipulation pairs stored in memory 114 in accordance with one aspect of the present disclosure. The object types may comprise anything that can be seen or physically touched, including common or inanimate objects (e.g., pens, watches, coins, rings). The objects themselves may also be incapable of transmitting information to the computing device. As shown in FIG. 3, object type 320 may relate to a clickable writing utensil such as a clickable pen or pencil, object type 340 may relate to a watch, and object type 360 may relate to a ring that one can wear on their finger.

An object type may be associated with visual and/or audio characteristics. By way of example only, visual characteristics 322 may identify particular shapes (e.g., cylindrical), sizes (e.g., height and width), colors and distinguishing features (e.g., numbers printed on the object), and audio characteristics 324 may identify particular audio signal characteristics such as the sound of a pen click. Visual characteristics 322 and audio characteristics 324 may identify the breadth and scope of the various objects that match the object type. For example, pen object type 320 may be considered to encompass any object that is similar in shape and size to a pen, or only objects that are identical in appearance to a specific pen.

A manipulation may be any form of moving, arranging, controlling, or handling of an object type. The manipulation may be associated with a common, socially acceptable use of the object type, e.g., a manipulation that many people commonly perform with the object and, as such, would not be overly distracting to others that view or hear the manipulation. Further, an object-manipulation pair may associate an object type with a manipulation of that object type. The object type and the manipulation corresponding with the object-manipulation pair may not be mutually exclusive.

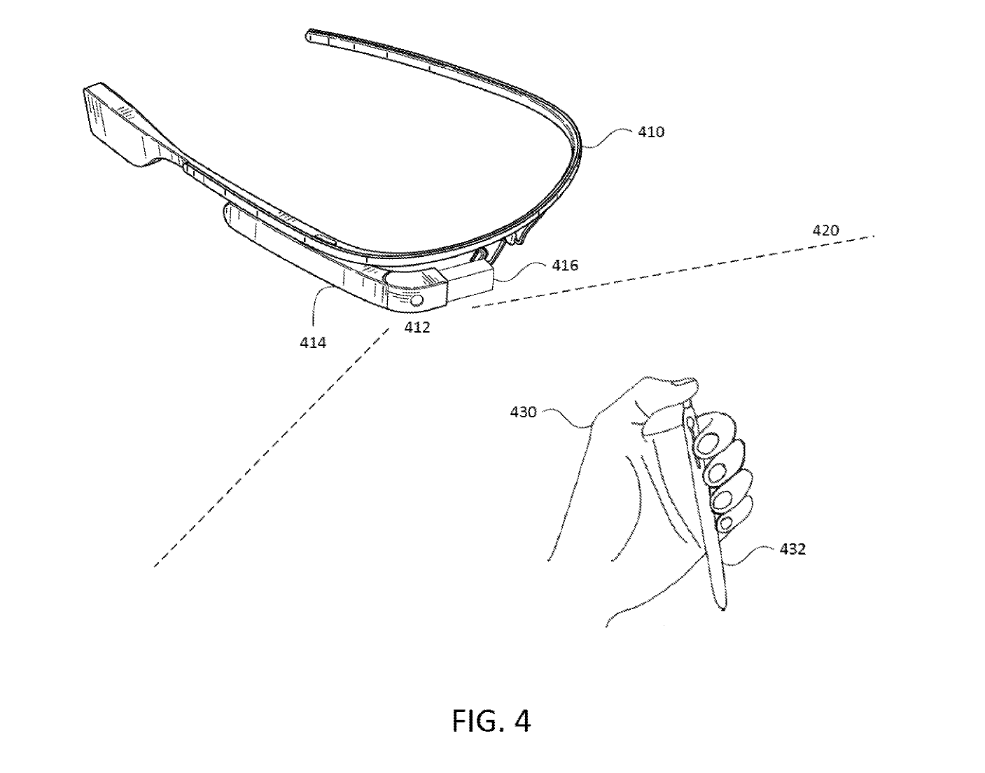

For instance, object-manipulation pair 326 may associate object type 320, e.g., a push-button pen, with the manipulation of clicking the pen's button. Object-manipulation pair 326 may be further associated with a command from executable commands 380. For example and as discussed in more detail below with regard to FIG. 4, when computing device(s) 110 determines that an object and a manipulation correspond with object-manipulation pair 326, for example, it may open up the e-mail application. Similarly, object-manipulation pairs 328 and 330 may associate pen object type 320 with the manipulation of clicking the pen's button twice and physically picking up the pen, respectively. Object-manipulation pairs 328 and 330 may also be associated with one or more corresponding commands from executable commands 380.

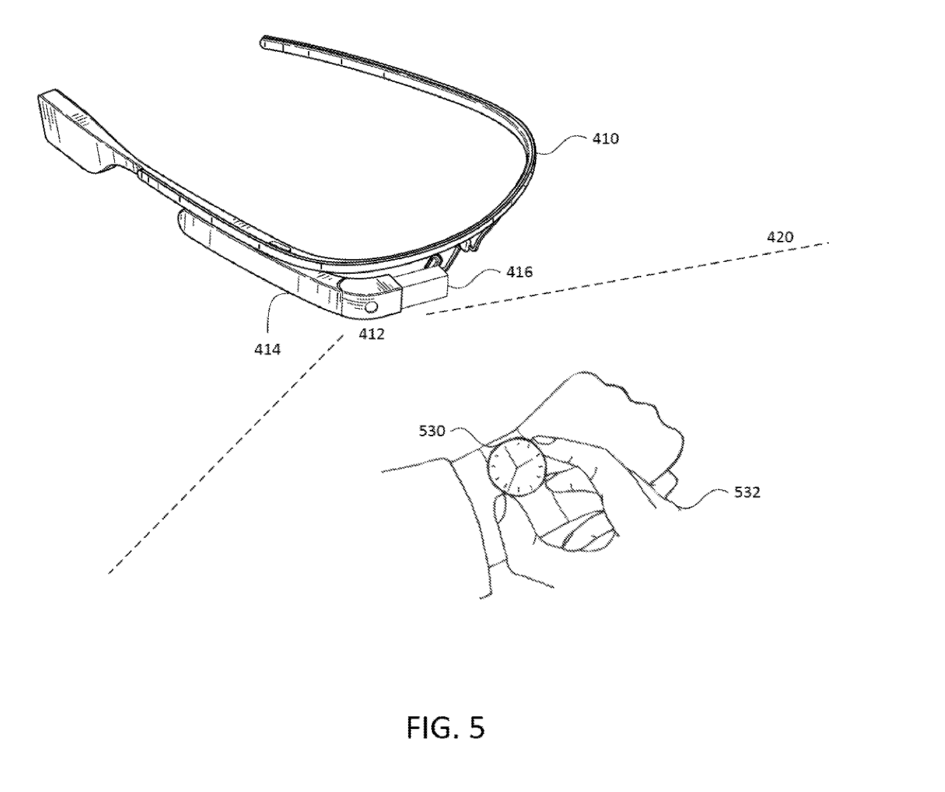

As further illustrated in FIG. 3, object type 340 may relate to a wearable timepiece, such as an analog or digital watch, and defined by visual characteristics 342. Visual characteristics 342 may include an hour hand, a minute hand, a second hand, a dial, or digital numbers. Object-manipulation pairs 344, 346, and 348 may associate object type 340 with manipulations of pinching the object type, tapping the glass of the object type twice, and rotating a finger along the outer surface of the object type, respectively. Similar to object-manipulation pairs 326, 328, and 330, object-manipulation pairs 344, 346, and 348 may be associated with corresponding commands from executable commands 380. In this regard and as discussed in more detail with regard to FIG. 5, when computing device(s) 110 determines that an object type and a manipulation correspond with object-manipulation pair 344, for instance, it may open up the calendar application.

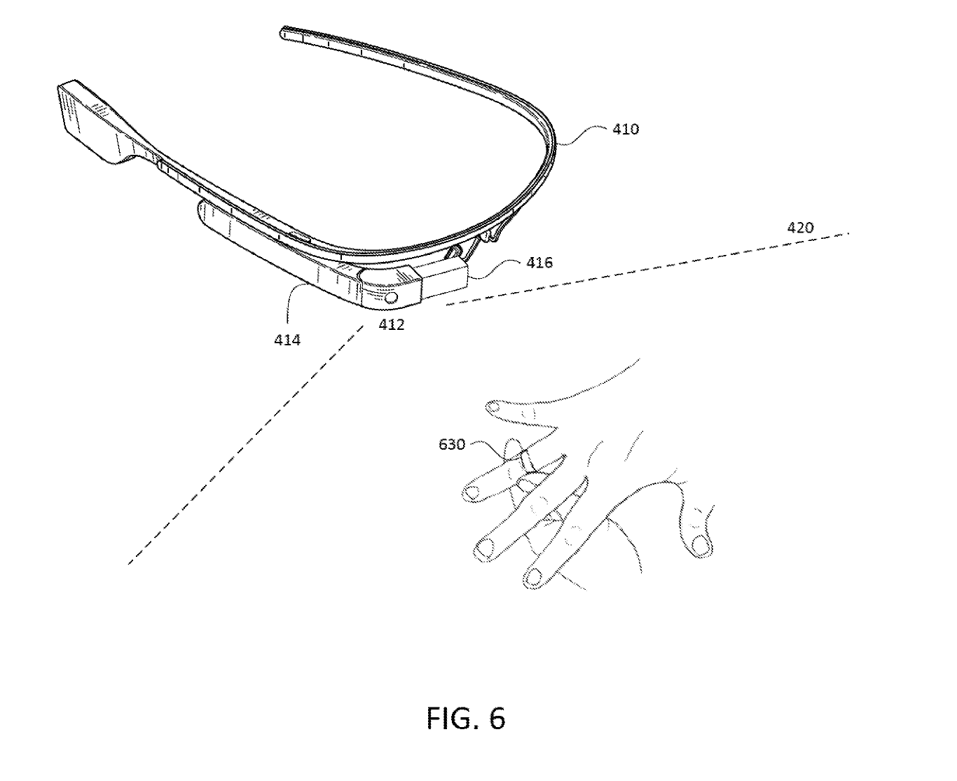

Object type 360 may relate to jewelry that can be worn on a user's finger, such as a ring, and defined by visual characteristics 362. Visual characteristics may include the object's location on a finger, metal, an ornament, and colors such as gold, silver, or platinum. Object-manipulations pairs 364, 366, and 368 may associate object type 360 with manipulations of rotating the object type, holding up user's fingers as the object type is worn, and tapping the object type three times, respectively. Like the aforementioned object-manipulation pairs above, object-manipulation pairs 364, 366, and 368 may also be associated with corresponding commands from executable commands 380. In this regard and as discussed in more detail with regard to FIG. 6, when computing device(s) 110 determines that an object type and a manipulation corresponds with object-manipulation pair 364, for example, it may dial the user's spouse's cellular phone number.

Executable commands may relate to and range from simple device-specific tasks (e.g., dial number) to complex combinations of application-specific tasks (e.g., search for nearby restaurants and sort the results by user rating). For example, executable commands 380 may comprise: open e-mail application, open new e-mail, open drawing application, open calendar application, create new calendar entry, toggle calendar cursor, dial spouse's cellular phone number, display anniversary date, and open movie ticket application. Executable commands may be associated with a particular input, and the input may be associated with a particular manipulation of an object type. An input may be any type of information put in, taken in, or operated on by a CPU or GPU. Although common examples of executable commands pertain to controlling/displaying applications installed on a computing device, other aspects of the subject matter described above are not limited to any particular type of command. For instance, an executable command may be as simple as a signal to start a process and executing the command starts the relevant process.

While FIG. 3 depicts data 118 of computing device(s) 110 in FIG. 1, the various object types, visual characteristics, audio characteristics, object-manipulation pairs, and/or executable commands may reside in memory 144 of server computer(s) 140, storage system 150, or other memory components communicating with network 160. Accordingly, a user may be able to download the object types, visual characteristics, audio characteristics, object-manipulation pairs, and/or executable commands to a computing device. The user may also be able to manually add the data to a computing device. Moreover, a computing device may receive instructions from the user to store a particular object-manipulation pair and associate the object-manipulation pair with a particular input or command. In that regard, the user may have the option of customizing the user's own object-manipulation pairs and their associated executable commands.

Example Methods

Operations in accordance with a variety of aspects of embodiments will now be described. It should be understood that the following operations do not have to be performed in the precise order described below. Rather, various steps can be handled in reverse order or simultaneously.

FIGS. 4-6 are illustrative examples of a computing device capturing a user manipulating different inanimate objects based on object types 320, 340, and 360 shown in FIG. 3. In one aspect, a pen may be manipulated by a user's hand. FIG. 4 provides an illustration of such a manipulation, namely a user's thumb 430 clicking a pen 432. The manipulation of the pen 432 is captured by camera 412 enclosed in housing 414 of wearable computing device 410, which may also enclose a CPU or GPU, one or more processors, memory storing instructions and data, as well as a microphone (not shown). The dashed lines extending out horizontally from camera 412 represents the camera's field of view 420, and is not limited horizontally.

In one example, as shown in FIG. 4, a user may grasp and hold pen 432 within the field of view 420 of camera 412. Subsequently, the user may single-click the top of pen 432 with his or her thumb 430. Wearable computing device 410, via its camera 412 and CPU or GPU, may observe, detect, and/or interpret that pen 432 is associated with certain visual and/or audio characteristics of an object type. For instance, computing device 410 may receive a first image and a second image of object 432 and use object recognition techniques to determine whether the object matches the visual characteristics of one of the object types, e.g., whether the object has an elongated cylindrical shape. Moreover, computing device 410, using its microphone, may determine that pen 432 makes a clicking noise. Based on these characteristics, wearable computing device 410 may determine that pen 432 corresponds with visual characteristics 322 and audio characteristics 324 as shown in FIG. 3 and further determine that pen 432 is associated with pen object type 320.

Wearable computing device 410, via its camera 412 and CPU or GPU, may additionally observe, detect, and/or interpret that a manipulation of the determined object type has occurred. For example, computing device 410 may determine that user's thumb 430 single-clicked the top of pen 432 based on the microphone's detection and reception of a clicking noise, and based on the images captured by the camera, e.g., by using object recognition to identify the user's thumb relative to the pen 432, and further determining that the thumb moved towards the pen at relatively the same time as the clicking noise was received. Upon determining the object type and manipulation of that object type, wearable computing device 410 may subsequently determine whether there is an association between the determined object type and manipulation thereof, e.g., an object-manipulation pair. In this example, a user's thumb 430 single-clicking the top of pen 432 may be associated with object-manipulation pair 326 as described above with regard to FIG. 3. Computing device 410 may execute a command associated with object-manipulation pair 326. The command may be based on either the object type or the manipulation of that object type, or both. For instance, object-manipulation pair 326 may be associated with opening an e-mail application.

In another example, wearable computing device 410 may determine that user's thumb 430 double-clicked the top of pen 432. Similar to the example above, computing device 410 may subsequently determine that double-clicking pen 432 corresponds with object-manipulation pair 328. Based on this determination, computing device 410 may execute the command associated with object-manipulation pair 328, e.g., open a new e-mail. In another instance, wearable computing device 410 may determine that user's hand is physically picking up pen 432 and holding it within the field of view 420 of camera 412. Computing device 410 may determine that physically picking up pen 432 corresponds with object-manipulation pair 330. Based on this determination, computing device 410 may execute the command associated with object-manipulation pair 330, e.g., open a drawing application.

While FIG. 4 illustrates one example of an object-manipulation pair, the object may not be limited to a pen and the manipulation may not be limited to click(s) of the pen. In another object-manipulation pair example, a user may twirl a pencil between the user's index and middle fingers. This particular object-manipulation pair may be associated with opening up a notepad application.

In another aspect, a wearable timepiece may be manipulated by a user's hand. FIG. 5 provides an illustration of such a manipulation, namely a user's hand 532 touching the outer circumference of watch 530 is captured and processed by wearable computing device 410.

As shown in FIG. 5, a user may touch and pinch the outer circumference of watch 530 using his or her thumb and index fingers. Similar to the example depicted in FIG. 4, camera 412 of wearable computing device 410 may observe, detect, and/or interpret within its field of view 420 that watch 530 corresponds to certain visual characteristics of an object type. Computing device 410 may receive one or more images of the object type and employ object recognition techniques to determine whether the object matches the visual characteristics of one of the object types. Depending on the visual characteristics and the analysis, computing device 410 may determine that watch 530 corresponds with visual characteristics 342 as depicted in FIG. 3 and further determine that watch 530 is associated with watch object type 340.

Camera 412 of wearable computing device 410 may also observe and detect within its field of view 420 that a manipulation of the determined object type has occurred. In one instance, it may determine that a user's thumb and index fingers pinched the outer circumference of watch 530. This determination may be based on object recognition of the thumb and index fingers' proximity to the outer circumference of the watch. Once the object type and manipulation of that object type have been determined by computing device 410, it may subsequently determine that the user's thumb and index fingers pinching the outer circumference of watch 530 is associated with object-manipulation pair 344 as described above with regard to FIG. 3. And computing device 410 may then execute a command associated with object-manipulation pair 344, such as opening up a calendar application.

In another instance, wearable computing device 510 may determine that user's index finger successively tapped twice the glass of watch 530. Similar to the example above, computing device 510 may subsequently determine that the double-tap of the glass of watch 530 corresponds with object-manipulation pair 346. Based on this determination, computing device 510 may execute the command associated with object-manipulation pair 346, e.g., open new calendar entry. In a further instance, computing device 510 may determine that user's thumb and index fingers are not only pinching the outer circumference of watch 530, but simultaneously rotating user's fingers clockwise. Computing device 510 may determine that watch 530 and the act of rotating its outer circumference corresponds with object-manipulation pair 348. Based on this determination, computing device 510 may execute the command associated with object-manipulation pair 348, e.g., toggling the calendar cursor. A clockwise rotation of the outer circumference may toggle the calendar cursor forward. Similarly, a counter-clockwise rotation of the outer circumference may toggle the calendar cursor backward.

In a further aspect, piece(s) of jewelry worn on a user's hand may be manipulated by the user. Jewelry is not limited to just rings or the type material they are made of, but may broadly comprise any type of ornament or piece of fashion that can be worn on or near the user's fingers or hands. FIG. 6 provides an illustration of a user's thumb and index fingers rotating a ring 630 captured and processed by wearable computing device 410. Like the examples depicted in FIGS. 4 and 5, the manipulation of the ring 630 is captured by camera 412 of computing device 410 within its field of view 420.

Like the manipulation example described above with regard to FIG. 5, a user may touch and pinch the outer circumference of ring 630 with the user's thumb and index fingers. While worn, the user may then physically rotate ring 630 in either direction. Based on one or more images captured by camera 412 of wearable computing device 410, it may observe and detect that ring 630 is connected to certain visual characteristics of object type 360, as seen in FIG. 3, based on the location of ring 630 and type and color of the ring's metal.

Upon the detection and determination of object type 630, camera 412 of computing device 410 may detect the occurrence of a manipulation of that object type. By way of example only, a user's thumb and index fingers may pinch and rotate ring 630 while it is still worn on the user's finger. Computing device 410 may subsequently determine that this manipulation of object type 360 is associated with object-manipulation pair 364 as described above with regard to FIG. 3. Based on this association, a command associated with object-manipulation pair 364 may be executed, such as dialing user's spouse's cellular telephone number.

Another example of manipulating object type 360 may involve a user holding up and fully extending his or her ring hand within the camera's field of view 420 while simultaneously pointing to ring 630 with the user's other hand. Wearable computing device 410 may subsequently determine that this manipulation corresponds with object-manipulation pair 366 and execute the command associated with pair 366, such as displaying on display 416 the user's anniversary date. In a further example, wearable computing device 410 may detect that the user tapped the surface of ring 630 three consecutive times. By using object recognition to identify the user's finger movement relative to the ring and the number of times it was tapped, computing device 410 may determine that this manipulation corresponds with object-manipulation pair 368 and execute the command associated with pair 368, for instance, opening the movie ticket application.

As already alluded to above with regard to FIGS. 1 and 2, wearable computing device 410 may have access to more than just the object types, object-manipulation pairs, and executable commands depicted in FIGS. 3-6. By way of another example only, the wearable computable device 410 may detect a user opening up his or her wallet. The association between the wallet and the act of opening it may correspond with an object-manipulation pair associated with a command to open a virtual wallet application.

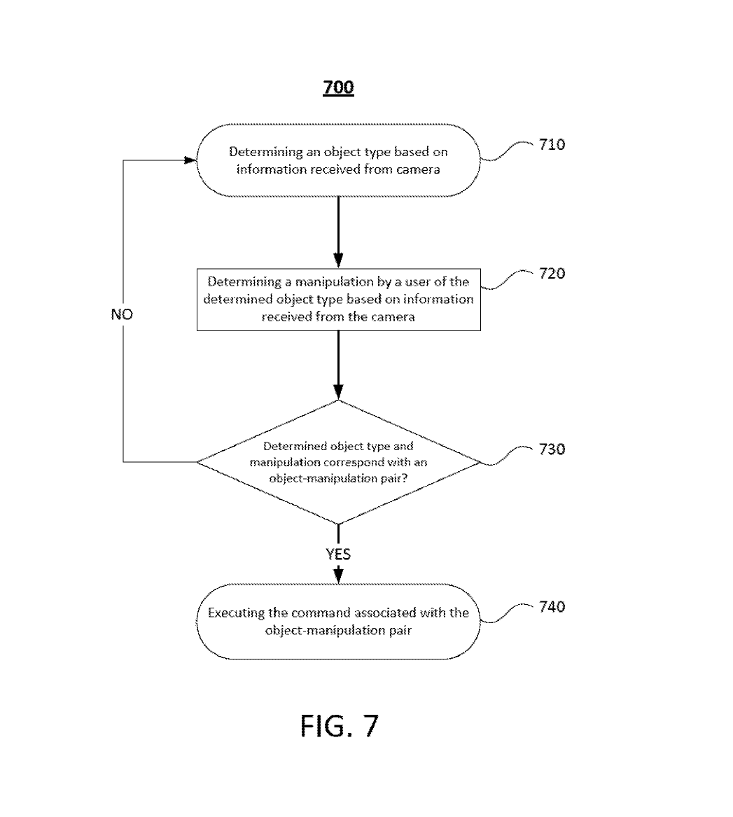

FIG. 7 is a flow diagram 700 depicting an example instruction set stored in memory of a system for detecting as input physical manipulations of objects in accordance with an aspect of the present disclosure. At block 710, at least one computing device determines an object type based on information received from one or more cameras that may be coupled to the computing device. As alluded to above and by way of example only, the received information may be a series of images. Similarly, at block 720, the computing device determines a manipulation of the determined object type by a user of the determined object type based on the information received by the one or more cameras. The computing device analyzes the visual and/or audio features of the object type and determines whether the detected object type and the determined manipulation correspond with an object-manipulation pair stored in memory at block 730. Examples of these determinations were described above with regard to FIGS. 3-6. When the determination is made at block 730, the computing device executes a command associated with the object-manipulation pair at block 740. When the determination cannot be made, the computing device reverts back to block 710.

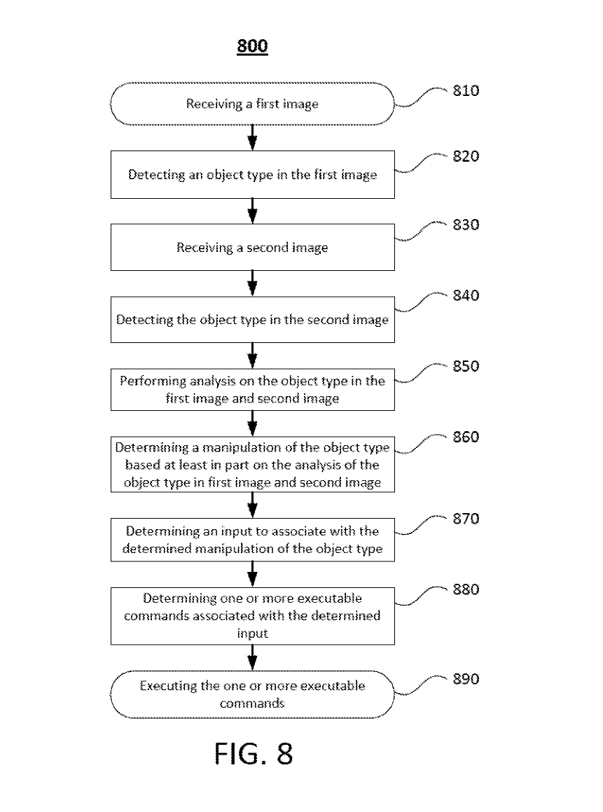

FIG. 8 is a flow diagram 800 depicting a method for detecting as input physical manipulations of objects in accordance with an aspect of the present disclosure. Using one or more computing devices, the method comprises receiving a first image at block 810. As described above with regard to FIG. 7, the first image may be received from one or more cameras that may be coupled to the one or more computing devices. At block 820, the method further comprises detecting an object type in the first image. Similarly, at block 830 the method comprises receiving a second image from the one or more cameras, and detecting the object type in the second image. Once the object type is detected in the first image and the second image, block 850 involves performing analysis on the object type in the first and second images. As described above with regard to FIGS. 4-6, the analysis may be based on visual, audio, or other types of information from the images.

At block 860, the method further comprises determining a manipulation of the object type based at least in part on the analysis of the object type at block 850. Block 870 involves determining an input to associate with the determined manipulation of the object type. At block 880, the method further comprises determining one or more executable commands associated with the determined input, and executing the one or more executable commands at block 890.

As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A method for detecting as input physical manipulations of objects, comprising:
receiving, using one or more computing devices, a first image;
detecting, using one or more computing devices, an object type in the first image;
receiving, using one or more computing devices, a second image;
detecting, using one or more computing devices, the object type in the second image;
performing analysis, using the one or more computing devices, on the object type in the first image and second image;
determining, using the one or more computing devices, a manipulation of the object type based at least in part on the analysis of the object type in the first image and the second image;
determining, using the one or more computing devices, an input to associate with the determined manipulation of the object type;
determining, using the one or more computing devices, one or more executable commands associated with the determined input; and
executing, using the one or more computing devices, the one or more executable commands.

2. The method of claim 1, wherein the one or more computing devices comprises at least one camera and a display device for displaying information in response to the execution of the one or more executable commands.

3. The method of claim 2, wherein the one or more computing devices further comprise at least one microphone to receive audio.

4. The method of claim 2, wherein the one or more computing devices is wearable and the at least one camera is disposed on or near a user's body when worn.

5. The method of claim 1, wherein determining the manipulation is not based on the determined object transmitting information identifying the manipulation to the one or more computing devices.

6. The method of claim 1, wherein the manipulation of the object is a common use of the object and the one or more executable commands associated with the determined input is related to the common use.

7. The method of claim 1, further comprising:
receiving, using the one or more computing devices, an instruction to store an association of an object type and a manipulation of the object type, wherein the association is an object-manipulation pair;
determining, using the one or more computing devices, the manipulation of the object type based at least in part on an analysis of the object type in a plurality of received images;
generating, using the one or more computing devices, the object-manipulation pair based at least in part on the determined object type and the determined manipulation thereof; and
storing the object-manipulation pair in memory of the one or more computing devices.

8. A system for detecting as input physical manipulations of objects, comprising:
a camera;
one or more computing devices; and
a memory storing a plurality of object types, an object-manipulation pair for each object type where each object-manipulation pair associates the object type with a manipulation of the object type, and at least one command associated with each object-manipulation pair, and instructions executable by the one or more computing devices;
wherein the instructions comprise:
determining an object type based on information received from the camera;
determining a manipulation by a user of the determined object type based on information received from the camera; and
when the determined object type and manipulation correspond with an object-manipulation pair of the determined object type, executing the command associated with the object-manipulation pair.

9. The system of claim 8, further comprising a microphone, and wherein the instructions further comprise determining a manipulation based on information received from the microphone.

10. The system of claim 9, wherein the system is wearable and the camera is disposed on or near the body of a user when worn.

11. The system of claim 8, wherein determining the manipulation is not based on the determined object type transmitting information identifying the manipulation to the one or more processors.

12. The system of claim 8, wherein the manipulation is a common use of the object type and the command is related to the common use.

13. The system of claim 8, wherein the instructions further comprise:
receiving an instruction to store an object-manipulation pair;
determining an object type and a user's manipulation of the object type based on information received from the camera;
based on the determined object type and manipulation, generating a new object-manipulation pair; and
storing the new object-manipulation pair in the memory.

14. The system of claim 8, further comprising a display device, and wherein the instructions further comprise displaying information in response to execution of the command.

15. The system of claim 8, wherein the object type is based at least in part with one or more visual characteristics, wherein the visual characteristic defines at least one visual characteristic of the object type.

16. The system of claim 9, wherein the object type is based at least in part with one or more audio characteristics, wherein the audio characteristic defines at least one audio characteristic of the object type.

17. A non-transitory, tangible computer-readable medium on which instructions are stored, the instructions, when executed by one or more computing devices to perform a method, the method comprising:
receiving a first image;
detecting an object in the first image;
receiving a second image;
detecting the object in the second image;
performing analysis on the object in the first image and second image;
determining a manipulation of the object based at least in part on the analysis of the object in the first image and the second image;
determining an input to associate with the determined manipulation of the object;
determining one or more executable commands associated with the determined input; and
executing the one or more executable commands.

18. The non-transitory, tangible computer-readable medium of claim 17, wherein the one or more computing devices comprises at least one camera and a display device for displaying information in response to the execution of the one or more executable commands.

19. The non-transitory, tangible computer-readable medium of claim 17, wherein determining a manipulation is not based on the determined object transmitting information identifying the manipulation to the one or more computing devices.

20. The non-transitory, tangible computer-readable medium of claim 17, wherein the instructions perform the method further comprising:
receiving, using the one or more computing devices, an instruction to store an association of an object type and a manipulation of the object type, wherein the association is an object-manipulation pair;
determining, using the one or more computing devices, the manipulation of the object based at least in part on an analysis of the object in a plurality of received images;
generating, using the one or more computing devices, the object-manipulation pair based at least in part on the determined object and the determined manipulation thereof;
storing the object-manipulation pair in memory of the one or more computing devices.
